(19) United States
(12) Patent Application Publication
(10) Pub. No.: US 2026/0370165 A1
(43) Pub. Date: Nov. 19, 2026

(54) METHOD, APPARATUS AND SYSTEM FOR CONTROLLING STEPPING ELECTRIC MOTOR

(71) Applicant: Tianjin Hualai Technology Co., Ltd., Tianjin (CN)

(72) Inventors: Zhibin PANG, Tianjin (CN); Shuxi ZHANG, Tianjin (CN); Yang GUO, Tianjin (CN); Guoqing WANG, Tianjin (CN); Fei LIU, Tianjin (CN); Daoqiu WANG, Tianjin (CN); Kechen AI, Tianjin (CN); Huaizhong XIE, Tianjin (CN); Yanping TAN, Tianjin (CN); Xiaoying SHI, Tianjin (CN)

(21) Appl. No.: 19/478,244

(22) PCT Filed: Oct. 24, 2023
(86) PCT No.: PCT/CN2023/126288

§ 371 Date: Oct. 23, 2025

(30) Foreign Application Priority Data
Apr. 23, 2023 (CN) 202310445406.X

(51) Int. Cl. H02P 8/22

(52) U.S. Cl. CPC H02P 8/22

(57) ABSTRACT

The present disclosure relates to the field of stepping motor control, and in particular, to a method, device, and system for controlling a stepping motor. The method is applied to a subdivision controller corresponding to the stepping motor, and the subdivision controller is connected to a main control circuit. The subdivision controller is connected to the stepping motor and includes a first register. The subdivision controller controls carrier frequencies output to the stepping motor according to a current value of the first register, so as to control a current operating state of the stepping motor. By means of the present disclosure, carrier frequencies corresponding to values of the first register are provided by calculating and modifying the values of the first register, and the carrier frequencies are output to the stepping motor to achieve a target subdivision mode, realizing automatic calculation and adjustment.

### CROSS-REFERENCE TO RELATED APPLICATIONS

The present disclosure claims priority to Chinese patent application No. 202310445406X, field with the China National Intellectual Property Administration on Apr. 23, 2023, and entitled “Method, Device, and System for Controlling Stepping Motor”, the entire contents of which are hereby incorporated by reference.

### TECHNICAL FIELD

The present disclosure relates to the technical field of stepping motor control, and in particular, to a method, device, and system for controlling a stepping motor.

### BACKGROUND

A stepping motor is a control stepping motor that directly converts digital information into angular or linear displacement, which is a main actuation element in a modern digital program control system and is widely used due to its simple control, quick start and stop, and precise stepping characteristics.

Currently, a stepping control system offers multi-level subdivision choices. The larger the subdivision number is, the closer the current waveform of the stepping motor approaches a sine wave, and the smoother the operation of the stepping motor becomes.

However, in the application of related technologies, the following technical defects are present: the subdivision mode of the stepping motor, once set, cannot be changed. Manual calculation and adjustment of the subdivision levels are required, making the operation cumbersome and prone to errors.

### SUMMARY

In view of this, an objective of the present disclosure is to provide a method, device, and system for controlling a stepping motor.

In a first aspect, an embodiment of the present disclosure provides a method for controlling a step motor, applied to a subdivision controller corresponding to the stepping motor, where the subdivision controller is connected to a main control circuit, the subdivision controller is connected to the stepping motor and includes a first register, the subdivision controller controls carrier frequencies output to the stepping motor according to a current value of the first register, so as to control a current operating state of the stepping motor, the subdivision controller stores a first corresponding relationship indicating one-to-one correspondence between operating states of the stepping motor and the carrier frequencies, the first register includes a first sub-unit, and the subdivision controller also stores a second corresponding relationship indicating one-to-one correspondence between subdivision levels and values of the first sub-unit; the method including: receiving an adjustment command sent by the main control circuit, where the command carries a target operating state of the stepping motor; searching for a target carrier frequency corresponding to the target operating state from the first corresponding relationship; acquiring a current subdivision level and a current carrier frequency of the stepping motor; calculating a target subdivision level according to the current subdivision level, the current carrier frequency, and the target carrier frequency; searching for a target value of the first sub-unit corresponding to the target subdivision level from the second corresponding relationship; determining a target value of the first register according to the target value of the first sub-unit; and modifying the current value in the first register to the target value to drive the stepping motor to operate according to the target operating state.

In a second aspect, the present disclosure provides a device for controlling a step motor, applied to a subdivision controller corresponding to the stepping motor, where the subdivision controller is connected to a main control circuit, the subdivision controller is connected to the stepping motor and includes a first register, the subdivision controller controls a current operating state of the stepping motor according to a current value of the first register, the subdivision controller stores a first corresponding relationship indicating one-to-one correspondence between operating states of the stepping motor and carrier frequencies, the first register includes a first sub-unit, and the subdivision controller also stores a second corresponding relationship indicating one-to-one correspondence between subdivision levels and values of the first sub-unit; the device including: a receiving module, configured to receive an adjustment command sent by the main control circuit, where the command carries a target operating state of the stepping motor; a first searching module, configured to search for a target carrier frequency corresponding to the target operating state from the first corresponding relationship; an acquisition module, configured to acquire a current subdivision level and a current carrier frequency of the stepping motor; a calculation module, configured to calculate a target subdivision level according to the current subdivision level, the current carrier frequency, and the target carrier frequency; a second searching module, configured to search for a target value of the first sub-unit corresponding to the target subdivision level from the second corresponding relationship; a determination module, configured to determine a target value of the first register according to the target value of the first sub-unit; and a modification module, configured to modify the current value in the first register to the target value to drive the stepping motor to operate according to the target operating state.

In a third aspect, the present disclosure provides a system for controlling a stepping motor, including the above-mentioned device.

The embodiments of the present disclosure bring about the following beneficial effects: the present disclosure provides a method, device, and system for controlling a stepping motor. The method is applied to a subdivision controller corresponding to the stepping motor, where the subdivision controller is connected to a main control circuit; the subdivision controller is connected to the stepping motor and includes a first register; the subdivision controller controls carrier frequencies output to the stepping motor according to a current value of the first register, so as to control a current operating state of the stepping motor; the subdivision controller stores a first corresponding relationship indicating one-to-one correspondence between operating states of the stepping motor and the carrier frequencies; the first register includes a first sub-unit; and the subdivision controller also stores a second corresponding relationship indicating one-to-one correspondence between subdivision levels and values of the first sub-unit. The method includes: receiving an adjustment command sent by the main control circuit, where the command carries a target operating state of the stepping motor; searching for a target carrier frequency corresponding to the target operating state from the first corresponding relationship; acquiring a current subdivision level and a current carrier frequency of the stepping motor; calculating a target subdivision level according to the current subdivision level, the current carrier frequency, and the target carrier frequency; searching for a target value of the first sub-unit corresponding to the target subdivision level from the second corresponding relationship; determining a target value of the first register according to the target value of the first sub-unit; and modifying the current value in the first register to the target value to drive the stepping motor to operate according to the target operating state.

By means of the present disclosure, carrier frequencies corresponding to values of the first register are provided by calculating and modifying the values of the first register, and the carrier frequencies are output to the stepping motor to achieve a target subdivision mode, realizing automatic calculation and adjustment, thereby reducing manual calculation and adjustment errors and improving the control accuracy.

Other features and advantages of the present disclosure will be set forth in the following specification, and in part will become apparent from the specification, or may be learned by practicing the present disclosure. The objectives and other advantages of the present disclosure will be realized and attained by the structure particularly pointed out in the specification, claims, and accompanying drawings.

To make the above-mentioned objectives, features, and advantages of the present disclosure more comprehensible, preferred embodiments are described in detail below with reference to the accompanying drawings.

### BRIEF DESCRIPTION OF DRAWINGS

To more clearly illustrate the specific implementations of the present disclosure or the technical solutions in the prior art, the accompanying drawings to be used in the descriptions of the specific implementations or prior art will be briefly introduced below. Apparently, the drawings described below are some implementations of the present disclosure. Those skilled in the art can also obtain other drawings based on these drawings without creative effort.

FIG. 1 is a flowchart of a method for controlling a stepping motor provided by an embodiment of the present disclosure.

FIG. 2 is a flowchart of another method for controlling a stepping motor provided by an embodiment of the present disclosure.

FIG. 3 is a flowchart of yet another method for controlling a stepping motor provided by an embodiment of the present disclosure.

FIG. 4 is a structural diagram of a device for controlling a stepping motor provided by an embodiment of the present disclosure.

FIG. 5 is a schematic diagram of a connection structure in a system for controlling a stepping motor provided by an embodiment of the present disclosure.

### REFERENCE NUMERALS IN THE DRAWINGS

10—Receiving module, 20—First searching module, 30—Acquisition module, 40—Calculation module, 50—Second searching module, 60—Determination module, 70—Modification module.

### DETAILED DESCRIPTION OF THE EMBODIMENTS

To make the objectives, technical solutions, and advantages of the embodiments of the present disclosure clearer, the technical solutions of the present disclosure will be described clearly and completely in conjunction with the accompanying drawings. Apparently, the described embodiments are some, rather than all of the embodiments of the present disclosure. All other embodiments obtained by those skilled in the art based on the embodiments in the present disclosure without creative effort shall fall within the scope of protection of the present disclosure.

To facilitate understanding of the embodiments, the technical terms designed in the present disclosure will be briefly introduced below.

A stepping motor can convert electrical pulse signals into corresponding angular or linear displacement. Whenever a pulse signal is input, a rotor rotates by an angle or moves forward by one step. The output angular or linear displacement is proportional to the number of input pulses, and the rotational speed is proportional to the pulse frequency. Therefore, the stepping motor is also known as a pulse motor.

After introducing the technical terms involved in the present disclosure, the application scenarios and design concepts of the embodiments of the present disclosure will be briefly introduced.

In actual production and manufacturing processes, a stepping control system offers multi-level subdivision choices. The larger the subdivision number is, the closer the current waveform of the stepping motor approaches a sine wave, and the smoother the operation of the stepping motor becomes. However, in the practical application process, the subdivision mode of the stepper motor, once set, cannot be changed. Manual calculation and adjustment of the subdivision levels are required, making the operation cumbersome and prone to errors.

Based on this, an embodiment of the present disclosure provides a method for controlling a stepping motor, applied to a subdivision controller corresponding to the stepper motor. The subdivision controller is connected to a main control circuit. The subdivision controller is connected to the stepping motor and includes a first register. The subdivision controller controls carrier frequencies output to the stepping motor according to a current value of the first register, so as to control a current operating state of the stepping motor. The subdivision controller stores a first corresponding relationship indicating one-to-one correspondence between operating states of the stepping motor and the carrier frequencies. The first register includes a first sub-unit. The subdivision controller also stores a second corresponding relationship indicating one-to-one correspondence between subdivision levels and values of the first sub-unit. The subdivision controller further includes a processor and a memory, where the memory stores a computer program, and the processor executes the computer program in the memory to implement the method provided by this embodiment.

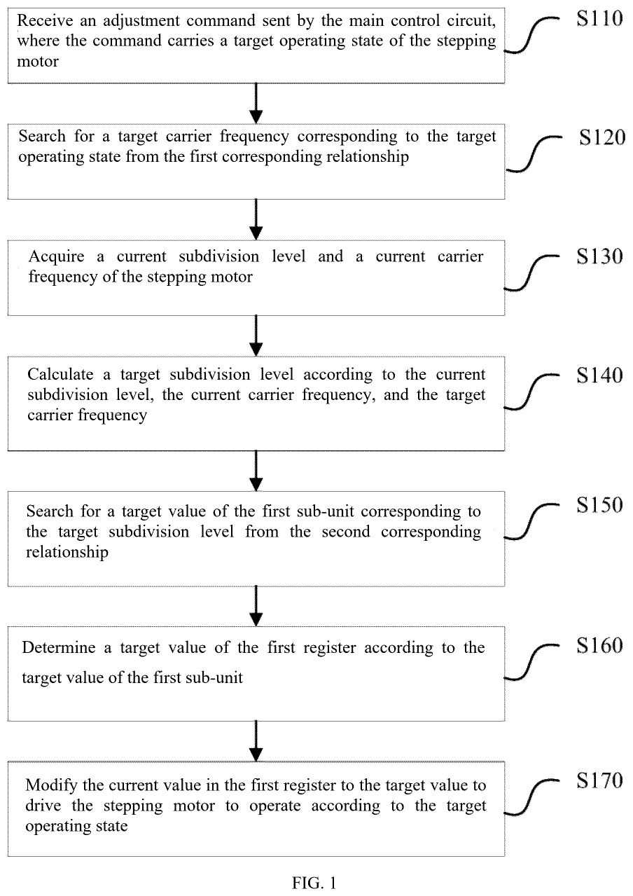

Referring to FIG. 1, the method for controlling a stepping motor provided by this embodiment includes the following steps S110 to S170.

In step S110, the processor receives an adjustment command sent by the main control circuit, where the command carries a target operating state of the stepping motor.

In step S120, the processor searches for a target carrier frequency corresponding to the target operating state from the first corresponding relationship.

In step S130, the processor acquires a current subdivision level and a current carrier frequency of the stepping motor.

In step S140, the processor calculates a target subdivision level according to the current subdivision level, the current carrier frequency, and the target carrier frequency.

In step S150, the processor searches for a target value of the first sub-unit corresponding to the target subdivision level from the second corresponding relationship.

In step S160, the processor determines a target value of the first register according to the target value of the first sub-unit.

In step S170, the processor modifies the current value in the first register to the target value to drive the stepping motor to operate according to the target operating state.

Specifically, the method for controlling a stepping motor provided by this embodiment includes: receiving an adjustment command for the stepping motor, searching for a target carrier frequency corresponding to a target operating state carried in the command, calculating a target subdivision level required to output the target carrier frequency, as well as a corresponding target value of the first sub-unit, determining a final target value of the first register, and modifying the current value of the first register to the target value to drive the stepping motor to operate according to the target operating state of the stepping motor, thereby achieving automatic conversion of motion states of the stepping motor, reducing the difficulty of manual debugging, lowering the error rate, and improving the control stability and convenience.

Specifically, in step S110, during the operation of the stepping motor, due to the need to rotate by a set angle for work, subdivision is required to reduce the vibration and stuttering caused by rotating a large angle in a single step. For example, if a target rotation angle is 90 degrees, it can be subdivided into 3 steps, with a rotation angle of 30 degrees in each step. During the operation or debugging of the stepping motor, when parameters such as subdivision levels and steps need to be modified, the main control circuit sends an adjustment command to the subdivision controller, and the subdivision controller receives the adjustment command sent by the main control circuit and acquires a target operating state of the stepping motor carried in the command.

In step S120, the current operating state of the stepping motor is acquired, specifically, the current subdivision level and the current carrier frequency of the stepping motor are acquired.

In step S130, after acquiring the current subdivision level and the current carrier frequency of the stepping motor in step S120, the processor calculates, according to the current subdivision level, the current carrier frequency, and the target carrier frequency, the target subdivision level in step S130 using the following formula:

Pn=(fx×Px)/fn,
where Pn is the target subdivision level, Px is the current subdivision level, fx is the current carrier frequency, and fn is the target carrier frequency.

After calculating the target subdivision level Pn in step S130, the target value of the first sub-unit corresponding to the target subdivision level Pn is searched from the second corresponding relationship.

In step S140, the target value of the first register is determined according to the target value of the first sub-unit, and in step S150, the current value of the first register is modified to the target value, and the corresponding target carrier frequency is output to drive the stepping motor to operate in the target operating state.

An example is provided as follows:
In this embodiment, it is assumed that, after receiving a target operating state of the stepping motor sent by a client, a target carrier frequency fn=26.88 kHz corresponding to the target operating state of the stepping motor is searched from the first corresponding relationship pre-stored in the subdivision controller.

The current subdivision level which is a 2-subdivision level, and the current carrier frequency f2=53.76 kHz are acquired.

In this case, the above-mentioned data is substituted into the formula Pn=(fx*Px)/fn, where Pn is the target subdivision level, Px is the current subdivision level, fx is the current carrier frequency, and fn is the target carrier frequency.

Pn=(2*53.76)/26.88=4 is obtained through calculation.

After obtaining the target subdivision level which is a 4-subdivision level, a target value of the first sub-unit corresponding to the subdivision level is found to be 0010 from the second corresponding relationship pre-stored in the subdivision controller.

The second corresponding relationship indicating one-to-one correspondence between the values of the first sub-unit and the subdivision levels in the subdivision controller is shown in Table 1.

TABLE 1
Corresponding relationship between values
of first sub-unit and subdivision levels

| Values of first sub-unit | Subdivision levels |
|---|---|
| 0000 | 1-subdivision |
| 0001 | 2-subdivision |
| 0010 | 4-subdivision |
| 0011 | 8-subdivision |
| 0100 | 16-subdivision |
| 0101 | 32-subdivision |
| 0110 | 64-subdivision |
| 0111 | 128-subdivision |

Based on the above-mentioned example, when the target level is a 4-subdivision level, the corresponding target value of the first sub-unit should be 0010.

The current value of the first register is modified according to the target value of the first sub-unit. Typically, the first register includes two sub-units. Values of the first sub-unit are configured to represent subdivision levels of the stepping motor, and values of the second sub-unit are configured to represent operating actions or directions of the stepping motor. In this embodiment, without considering action or direction conversion of the stepping motor, the value of the first register is modified to 0010 according to the value of the first sub-unit. In this way, the target carrier frequency is output to the stepping motor, thereby controlling the stepping motor to operate according to the target operating state, simplifying the adjustment operation. The entire process is automated, reducing manual operation errors.

In this embodiment, the subdivision levels correspond to subdivision steps and other information, such as 1 subdivision, 2 steps; 2 subdivisions, 4 steps, or the like.

As an implementable approach, referring to Table 1, a corresponding relationship can be established among the values in the first register, the subdivision levels of the stepping motor, the carrier frequencies, and the operating states of the stepping motor. In this embodiment, the target subdivision level is determined based on the known target operating state of the stepping motor, the current subdivision level, and the current carrier frequency, and the value of the first sub-unit is determined, thereby determining the target value of the first register. In this way, manual adjustment errors are reduced through automated search, calculation, determination, and modification operations.

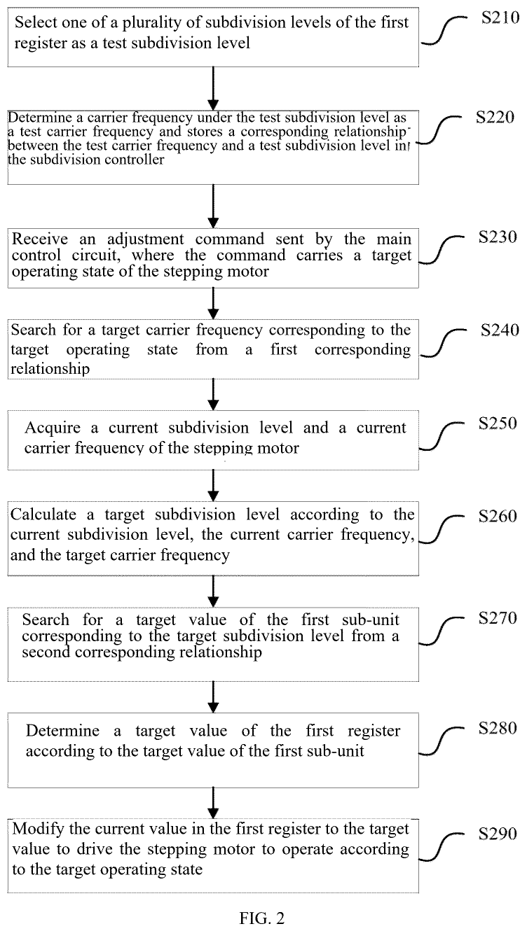

An embodiment provides another method for controlling a stepping motor, which is also applied to a subdivision controller. The subdivision controller is connected to a main control circuit. Referring to FIG. 2, the method provided by this embodiment includes the following steps S210 to S290.

In step S210, a processor selects one of a plurality of subdivision levels of the first register as a test subdivision level.

In step S220, the processor determines a carrier frequency under the test subdivision level as a test carrier frequency and stores a corresponding relationship between the test carrier frequency and a test subdivision level in the subdivision controller.

In step S230, the processor receives an adjustment command for the stepping motor sent by the main control circuit, where the command carries a target operating state.

In step S240, the processor searches for a target carrier frequency corresponding to the target operating state from a first corresponding relationship.

In step S250, the processor acquires a current subdivision level and a current carrier frequency of the stepping motor.

In step S260, the processor calculates a target subdivision level according to the current subdivision level, the current carrier frequency, and the target carrier frequency.

In step S270, the processor searches for a target value of the first sub-unit corresponding to the target subdivision level from a second corresponding relationship.

In step S280, the processor determines a target value of the first register according to the target value of the first sub-unit.

In step S290, the processor modifies the current value in the first register to the target value to drive the stepping motor to operate according to the target operating state.

In this embodiment, only the test subdivision level and test carrier frequency are pre-stored. After acquiring the current carrier frequency, the test subdivision level and test carrier frequency that are pre-stored are substituted into a preset calculation formula to calculate the current subdivision level, reducing manual calculation errors and improving the control accuracy.

In step S260, the step of acquiring the current level of the stepping motor includes the following steps S261 and S262.

In step S261, the processor searches for the current carrier frequency corresponding to the current operating state from the first corresponding relationship.

In step S262, the current subdivision level is calculated using the following formula:

Px=(f0×P0)/fx,
where P0 is the test subdivision level, Px is the current subdivision level, fx is the current carrier frequency, and f0 is the test carrier frequency.

In this embodiment, one of the plurality of subdivision levels is used as a test level, a test carrier frequency under this test level is acquired, and the two are associated and stored. Subsequently, during the operation of the stepping motor, when the subdivision level needs to be adjusted according to a working condition, an adjustment command for the stepping motor sent by a client is received, the target carrier frequency is determined, and the target subdivision level and the corresponding target value of the first register are determined according to the current carrier frequency and current subdivision level. The current subdivision level is calculated according to the test subdivision level, the test carrier frequency, and the current frequency that are pre-stored in the subdivision controller. In this way, the current carrier frequency is obtained through actual detection, while other data are automatically calculated according to data pre-stored in the subdivision controller, resulting in low error rate and high automatic adjustment accuracy.

In the method for controlling a stepping motor provided by this embodiment, the first register further includes a second sub-unit. The current value of the first register is composed of a current value of the second sub-unit and a current value of the first sub-unit. The subdivision controller stores a third corresponding relationship indicating one-to-one correspondence between the current value of the second sub-unit and a current action command. The action command at least includes: start, stop, clockwise rotation, and counterclockwise rotation.

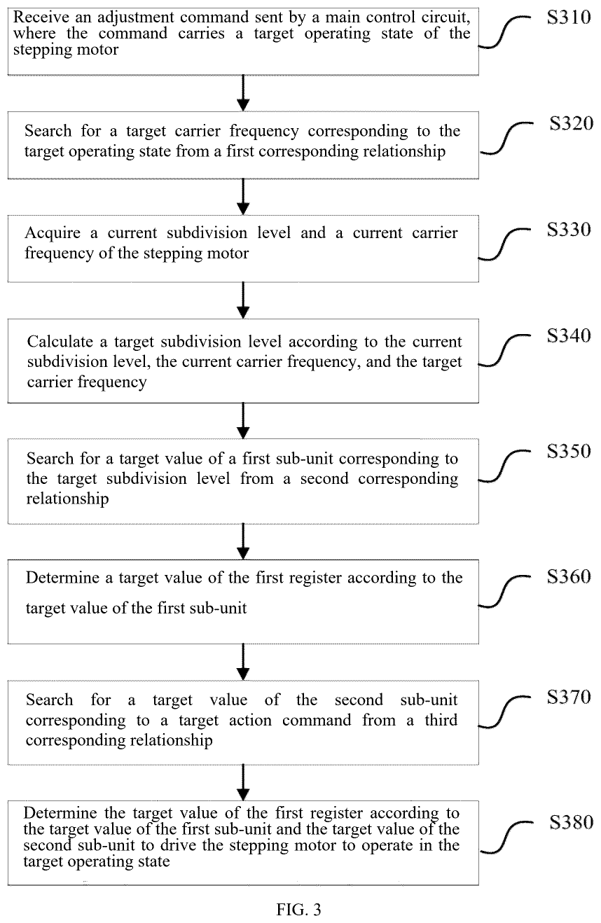

Referring to FIG. 3, in this embodiment, the command further includes a target action command. The method includes the following steps S310 to S380.

In step S310, a processor receives an adjustment command sent by a main control circuit, where the command carries a target operating state of the stepping motor.

In step S320, the processor searches for a target carrier frequency corresponding to the target operating state from a first corresponding relationship.

In step S330, the processor acquires a current subdivision level and a current carrier frequency of the stepping motor.

In step S340, the processor calculates a target subdivision level according to the current subdivision level, the current carrier frequency, and the target carrier frequency.

In step S350, the processor searches for a target value of a first sub-unit corresponding to the target subdivision level from a second corresponding relationship.

In step S360, the processor determines a target value of the first register according to the target value of the first sub-unit.

In step S370, the processor searches for a target value of the second sub-unit corresponding to a target action command from a third corresponding relationship.

In step S380, the processor determines the target value of the first register according to the target value of the first sub-unit and the target value of the second sub-unit to drive the stepping motor to operate in the target operating state.

In this embodiment, the values of the second sub-unit are in one-to-one correspondence with the action commands of the stepping motor. After receiving an adjustment command for the subdivision level in the adjustment command, a value of the second sub-unit corresponding to an action in the target operating mode is searched, and the target value of the first register is determined according to the values of the first sub-unit and the values of the second sub-unit, thereby modifying the value of the first register to drive the stepping motor to operate in the target operating state.

For example, the corresponding relationship between the values in the second sub-unit and the actions of the stepping motor is shown in Table 2.

TABLE 2
Corresponding relationship between values in
second sub-unit and actions of stepping motor

| | Operating modes of |
|---|---|
| Values in second sub-unit | stepping motor |
| 0000 | Output open circuit |
| 0101 | Clockwise rotation |
| 1010 | Counterclockwise rotation |
| 1111 | Brake |

The adjustment command sent by the main control circuit is received. The target operating state of the stepping motor in the command includes the actions and the target carrier frequency. The value (e.g., 0010) of the first sub-unit is determined according to the target carrier frequency in conjunction with the method for controlling a stepping motor. The value of the second sub-unit is determined from the third corresponding relationship according to the target action. For example, the target action is “counterclockwise rotation”, and the value of the second sub-unit corresponding to “counterclockwise rotation” is found to be “1010”; subsequently, the target value of the first register is determined by combining the target value of the first sub-unit and the target value of the second sub-unit; and thus, the target value is 10100010.

The current value of the first register is modified to the target value: 10100010, to drive the stepping motor to rotate counterclockwise and operate at the 4-subdivision level.

An embodiment provides another method for controlling a stepping motor, which is also applied to a subdivision controller. The subdivision controller further includes a second register and stores a fourth corresponding relationship indicating one-to-one correspondence between a current value of the first register and a current value of the second register. After the step of modifying the current value in the first register to the target value, the method further includes:
searching for a target value of the second register corresponding to the target value of the first register from the fourth corresponding relationship; and
modifying the current value in the second register to the target value to drive the stepping motor to operate according to a target operating state of the stepping motor.

As an implementable approach, the second register includes a third sub-unit and a fourth sub-unit. Values of the third sub-unit are configured to represent clock division, and values of the fourth sub-unit are configured to represent clock source division. The values of the second register are composed of the values of the third sub-unit and the values of the fourth sub-unit.

A corresponding relationship between the values of the third sub-unit and the clock division is shown in Table 3, and a corresponding relationship between the values of the fourth sub-unit and the clock source division is shown in Table 4.

TABLE 3
Corresponding relationship between values of
the third sub-unit and clock source division

| | |
|---|---|
| 000 | No division |
| 001 | 2 division |
| 010 | 4 division |
| 011 | 8 division |
| 100 | 16 division |
| 101 | 32 division |
| 110 | 64 division |
| 111 | 128 division |

TABLE 4
Corresponding relationship between values of
the fourth sub-unit and clock source division

| | |
|---|---|
| 00000 | chdivclk |
| 00001 | chdivclk/2 |
| 00010 | chdivclk/3 |
| 00011 | chdivclk/4 |
| 00100 | chdivclk/5 |
| 00101 | chdivclk/6 |
| 00110 | chdivclk/7 |
| 00111 | chdivclk/8 |
| 01000 | chdivclk/9 |

In this embodiment, the first register is driven to output the target carrier frequency by modifying the value of the second register, so as to drive the stepping motor to operate in the target operating state.

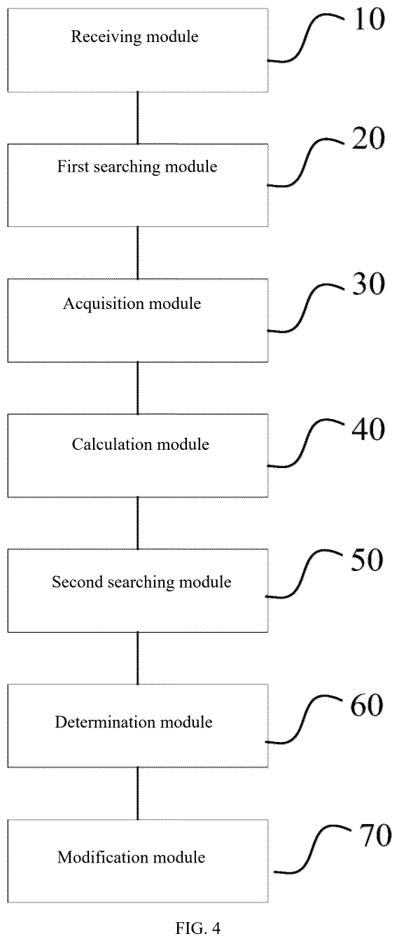

In a second aspect, an embodiment of the present disclosure also provides a device for controlling a stepping motor, which is applied to a subdivision controller corresponding to the stepping motor. The subdivision controller is connected to a main control circuit. The subdivision controller includes a first register. The subdivision controller controls carrier frequencies output to the stepping motor according to a current value of the first register, so as to control a current operating state of the stepping motor. The subdivision controller stores a first corresponding relationship indicating one-to-one correspondence between operating states of the stepping motor and the carrier frequencies. The first register includes a first sub-unit. The subdivision controller also stores a second corresponding relationship indicating one-to-one correspondence between subdivision levels and values of the first sub-unit. The subdivision controller stores a one-to-one corresponding relationship between a plurality of carrier frequencies and a plurality of subdivision modes of the stepping motor. Referring to FIG. 4, the device includes: a receiving module 10, a first searching module 20, an acquisition module 30, a calculation module 40, a second searching module 50, a determination module 60, and a modification module 70.

The receiving module 10 is configured to receive an adjustment command sent by the main control circuit, where the command carries a target operating state of the stepping motor.

The first searching module 20 is configured to search for a target carrier frequency corresponding to the target operating state from the first corresponding relationship.

The acquisition module 30 is configured to acquire a current subdivision level and a current carrier frequency of the stepping motor.

The calculation module 40 is configured to calculate a target subdivision level according to the current subdivision level, the current carrier frequency, and the target carrier frequency.

The second searching module 50 is configured to search for a target value of the first sub-unit corresponding to the target subdivision level from the second corresponding relationship.

The determination module 60 is configured to determine a target value of the first register according to the target value of the first sub-unit.

The modification module 70 is configured to modify the current value in the first register to the target value to drive the stepping motor to operate according to the target operating state.

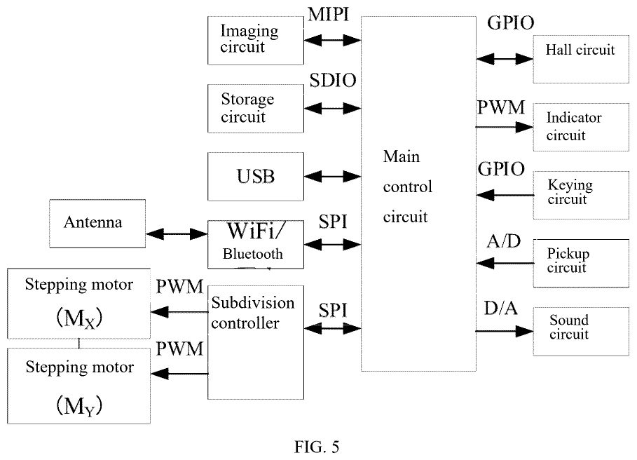

In a third aspect, an embodiment of the present disclosure provides a system for controlling a stepping motor, including the above-mentioned subdivision controller. Referring to FIG. 5, an input end of the subdivision controller is connected to an interface (SPI interface) of the main control circuit, and an output end is connected to the stepping motor.

Referring to FIG. 5, the main control circuit is also connected to other devices through different interfaces, for example, connected to a Hall circuit through a GPIO interface for information interaction or connected to an imaging circuit through an MIPI interface for information interaction, and connected to an indicator circuit, a keying circuit, a pickup circuit, a sound circuit, etc.

Using interface connections makes the connection mode simple and easy to operate.

For convenience and brevity of description, the specific working process of the above-described system and device can refer to the corresponding process in the aforementioned method embodiments, which will not be repeated here.

Additionally, in the description of the embodiment of the present disclosure, unless otherwise explicitly specified and defined, the terms “install”, “connect”, and “connection” should be understood in a broad sense. For example, they may be fixed connections, detachable connections, or integral connections; they may be mechanical connections or electrical connections; they may be direct connections or indirect connections through an intermediate medium; or they may be internal connections between two elements. For those skilled in the art, the specific meanings of the above-mentioned terms in the present disclosure can be understood according to specific situations.

If the functions are implemented in the form of software functional units and sold or used as independent products, they can be stored in one computer-readable storage medium. Based on this understanding, the technical solutions of the present disclosure, or parts contributing to the prior art, or part of the technical solutions can be embodied in the form of a software product. The computer software product is stored in one storage medium, including a plurality of instructions to enable a computer device (which may be a personal computer, a server, or a network device, etc.) to perform all or some of the steps of the methods described in the various embodiments of the present disclosure. The aforementioned storage medium includes: a USB flash drive, a mobile hard drive, a read-only memory (ROM), a random access memory (RAM), a magnetic disk, an optical disk, and various media capable of storing program codes.

In the description of the present disclosure, it should be noted that orientation or positional relationships indicated by terms such as “center”, “upper”, “lower”, “left”, “right”, “vertical”, “horizontal”, “inner”, and “outer” are based on the orientation or positional relationships shown in the drawings. They are merely for the convenience of describing the present disclosure and simplifying the description, rather than indicating or implying that the referred devices or elements must have specific orientations or be constructed and operated in specific orientations. Therefore, they should not be understood as limitations to the present disclosure. Additionally, the terms “first,” “second,” and “third” are merely for purpose of description and should not be understood as indicating or implying relative importance.

Finally, it should be noted that the above-mentioned embodiments are merely specific implementations of the present disclosure, and are intended to illustrate the technical solutions of the present disclosure rather than to limit them. The scope of protection of the present disclosure is not limited to these. Although the present disclosure has been described in detail with reference to the aforementioned embodiments, those skilled in the art should understand that any person skilled in the art can still make modifications to the technical solutions recorded in the aforementioned embodiments or easily conceive of variations, or make equivalent replacements for some technical features thereof. These modifications, variations or replacements do not cause the essence of the corresponding technical solutions to depart from the spirit and scope of the technical solutions of the embodiments of the present disclosure, and should all be covered within the scope of protection of the present disclosure. Therefore, the scope of protection of the present disclosure should be defined the scope of protection of the claims.

What is claimed is:

1. A method for controlling a stepping motor, applied to a subdivision controller corresponding to the stepping motor, wherein the subdivision controller is connected to a main control circuit, the subdivision controller is connected to the stepping motor and comprises a first register, the subdivision controller controls carrier frequencies output to the stepping motor according to a current value of the first register, so as to control a current operating state of the stepping motor, the subdivision controller stores a first corresponding relationship indicating one-to-one correspondence between operating states of the stepping motor and the carrier frequencies, the first register comprises a first sub-unit, and the subdivision controller also stores a second corresponding relationship indicating one-to-one correspondence between subdivision levels and values of the first sub-unit; the method comprising:
receiving an adjustment command sent by the main control circuit, wherein the command carries a target operating state of the stepping motor;
searching for a target carrier frequency corresponding to the target operating state from the first corresponding relationship;
acquiring a current subdivision level and a current carrier frequency of the stepping motor;
calculating a target subdivision level according to the current subdivision level, the current carrier frequency, and the target carrier frequency;
searching for a target value of the first sub-unit corresponding to the target subdivision level from the second corresponding relationship;
determining a target value of the first register according to the target value of the first sub-unit; and
modifying the current value of the first register to the target value to drive the stepping motor to operate according to the target operating state.

2. The method according to claim 1, wherein the step of calculating the target subdivision level according to the current subdivision level, the current carrier frequency, and the target carrier frequency comprises:
calculating according to the following formula:
Pn=(fx*Px)/fn,
where Pn is the target subdivision level, Px is the current subdivision level, fx is the current carrier frequency, and fn is the target carrier frequency.

3. The method according to claim 1, wherein before the step of receiving an adjustment command sent by the main control circuit, the method further comprises:
selecting one of a plurality of subdivision levels of the first register as a test subdivision level;
determining a carrier frequency under the test subdivision level as a test carrier frequency; and
storing a corresponding relationship between the test carrier frequency and the test subdivision level in the subdivision controller.

4. The method according to claim 3, wherein the step of acquiring the current subdivision level of the stepping motor comprises:
searching for the current carrier frequency corresponding to the current operating state from the first corresponding relationship; and
calculating the current subdivision level according to the following formula:
Px=(f0×P0)/fx,
where P0 is the test subdivision level, Px is the current subdivision level, fx is the current carrier frequency, and f0 is the test carrier frequency.

5. The method according to claim 1, wherein the first register further comprises a second sub-unit, and the current value of the first register is composed of a current value of the second sub-unit and a current value of the first sub-unit; and the subdivision controller stores a third corresponding relationship indicating one-to-one correspondence between the current value of the second sub-unit and a current action command, the action command at least comprising: start, stop, clockwise rotation, and counterclockwise rotation.

6. The method according to claim 5, wherein the command further comprises a target action command; and after the step of searching for the target value of the first sub-unit corresponding to the target subdivision level from the second corresponding relationship, the method further comprises:
searching for a target value of the second sub-unit corresponding to the target action command from the third corresponding relationship; and
determining the target value of the first register according to the target value of the first sub-unit and the target value of the second sub-unit.

7. The method according to claim 1, wherein the subdivision controller further comprises a second register and stores a fourth corresponding relationship indicating one-to-one correspondence between the current value of the first register and the current value of the second register; and after the step of modifying the current value in the first register to the target value, the method further comprises:
searching for a target value of the second register corresponding to the target value of the first register from the fourth corresponding relationship; and
modifying the current value in the second register to the target value to drive the stepping motor to operate according to the target operating state of the stepping motor.

8. The method according to claim 7, wherein the second register comprises a third sub-unit and a fourth sub-unit, values of the third sub-unit are configured to represent clock division, and values of the fourth sub-unit are configured to represent clock source division; and values of the second register are composed of the values of the third sub-unit and the values of the fourth sub-unit.

9. A device for controlling a stepping motor, applied to a subdivision controller corresponding to the stepping motor, wherein the subdivision controller is connected to a main control circuit, the subdivision controller is connected to the stepping motor and comprises a first register, the subdivision controller controls a current operating state of the stepping motor according to a current value of the first register, the subdivision controller stores a first corresponding relationship indicating one-to-one correspondence between operating states of the stepping motor and carrier frequencies, the first register comprises a first sub-unit, and the subdivision controller also stores a second corresponding relationship indicating one-to-one correspondence between subdivision levels and values of the first sub-unit; the device comprising:
a command receiving module, configured to receive an adjustment command sent by the main control circuit, wherein the command carries a target operating state of the stepping motor;
a first searching module, configured to search for a target carrier frequency corresponding to the target operating state from the first corresponding relationship;
an acquisition module, configured to acquire a current subdivision level and a current carrier frequency of the stepping motor;
a calculation module, configured to calculate a target subdivision level according to the current subdivision level, the current carrier frequency, and the target carrier frequency;
a second searching module, configured to search for a target value of the first sub-unit corresponding to the target subdivision level from the second corresponding relationship;
a determination module, configured to determine a target value of the first register according to the target value of the first sub-unit; and
a modification module, configured to modify the current value in the first register to the target value to drive the stepping motor to operate according to the target operating state.

10. A system for controlling a stepping motor, comprising the device according to claim 9.
